(19) United States
(12) Patent Application Publication
(10) Pub. No.: US 2026/0359347 A1
(43) Pub. Date: Nov. 12, 2026

(54) Machine-Learned Visual Chart Processing Using Nonvisual Chart Data

(71) Applicant: GDM Holding LLC, Mountain View, CA (US)

(72) Inventors: Jeshwanth Challagundla, Milpitas, CA (US); Alan Papir, Armonk, NY (US); Idan Heimlich Shtacher, Los Altos, CA (US)

(21) Appl. No.: 19/673,276

(22) Filed: May 11, 2026

Related U.S. Application Data
(60) Provisional application No. 63/804,337, filed on May 12, 2025.

(51) Int. Cl. G06F 16/44; G06F 16/435

(52) U.S. Cl. CPC G06F 16/44; G06F 16/435

(57) ABSTRACT

A computing system comprising one or more computing devices can obtain nonvisual data indicative of a visual chart. The computing system can provide, to a first machine-learned sequence processing model, at least a portion of the nonvisual data. The computing system can receive, from the first machine-learned sequence processing model, a language output based at least in part on the nonvisual data. The computing system can output the language output and the visual chart.

### PRIORITY CLAIM

The present application claims priority to U.S. Provisional Application No. 63/804,337, filed May 12, 2025, which is hereby incorporated by reference herein in its entirety.

### BACKGROUND

The present disclosure relates generally to machine learning processes and machine-learned devices and systems. A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system comprising one or more computing devices, a first dataset to be analyzed. The example method can include generating, by the computing system using a first machine-learned sequence processing model, one or more computer-readable instructions that are executable by one or more processors to cause the computing system to process the first dataset to generate a visual chart depicting one or more properties of the first dataset and corresponding nonvisual data indicative of the visual chart. The example method can include executing, by the computing system, the one or more computer-readable instructions to generate the visual chart and the nonvisual data indicative of the visual chart. The example method can include providing, by the computing system to the first machine-learned sequence processing model or a second machine-learned sequence processing model, at least a portion of the nonvisual data. The example method can include receiving, by the computing system from the first or second machine-learned sequence processing model, a language output based at least in part on the nonvisual data. The example method can include outputting, by the computing system, the language output and the visual chart.

In the example method, generating the one or more computer-readable instructions can include providing, by the computing system to the first machine-learned sequence processing model, data indicative of an application programming interface for processing raw data to generate nonvisual specifications of visual charts. In the example method, generating the one or more computer-readable instructions can include receiving, by the computing system from the first machine-learned sequence processing model, the one or more computer-readable instructions.

In the example method, the data indicative of the application programming interface can include one or more of: documentation data indicative of one or more function signatures of the application programming interface; and example data comprising one or more example computer-executable instructions for calling the application programming interface.

The example method can include sampling, by the computing system responsive to determining that a size of the nonvisual data is greater than a predetermined threshold, a subset of the nonvisual data. In the example method, providing at least a portion of the nonvisual data can include providing the subset.

In the example method, sampling the subset can include identifying, by the computing system, one or more first data items associated with one or more extrema of the nonvisual data. In the example method, sampling the subset can include including, by the computing system, the one or more first data items in the subset. In the example method, sampling the subset can include sampling, by the computing system, one or more second data items from a remainder of the nonvisual data.

In the example method, the one or more second data items can include uniform random sampling.

In the example method, the nonvisual data can include a plurality of chart object data items. In the example method, each respective chart object data item of the plurality of chart object data items can include one or more respective coordinates of the respective chart object data item on one or more chart axes of the visual chart.

In the example method, the nonvisual data can include text data indicative of one or more text labels associated with the visual chart.

In the example method, the nonvisual data can include a complete specification of the visual chart in a structured textual data format.

In the example method, the structured textual data format can include a grammar for describing visual charts.

The example method can include receiving, by the computing system from a user, a query indicative of a requested analysis of a set of raw data associated with the query. The example method can include providing, by the computing system to the first or second machine-learned sequence processing model or a third machine-learned sequence processing model, at least a portion of the query. The example method can include, for each of a plurality of iterations, receiving, by the computing system from the first or second or third machine-learned sequence processing model, an action selection output based at least in part on one or more of the query and result data generated during a previous iteration of the plurality of iterations. The example method can include, for each of the plurality of iterations, executing, by the computing system, one or more operations identified in the action selection output.

In the example method, the one or more operations for at least one iteration of the plurality of iterations can include executing the one or more computer-readable instructions to cause the computing system to generate the visual chart and the nonvisual data based on the first dataset.

In the example method, the one or more operations for at least one iteration of the plurality of iterations comprise outputting the language output and the visual chart.

In the example method, the one or more operations for at least one iteration of the plurality of iterations comprise obtaining the first dataset.

In the example method, the nonvisual data can be first nonvisual data. In the example method, the visual chart can be a first visual chart. In the example method, the first or second machine-learned sequence processing model can be a model that was trained by: providing, to the first or second machine-learned sequence processing model, one or more training inputs comprising second nonvisual data indicative of one or more second visual charts; generating, by the first or second machine-learned sequence processing model, one or more training outputs based on the one or more training inputs; and updating the first or second machine-learned sequence processing model based at least in part on the one or more training outputs.

In the example method, the visual chart can be a first visual chart. In the example method, the language output can be a first language output. The example method can include providing, by the computing system to the first or second machine-learned sequence processing model or a third machine-learned sequence processing model, a second visual chart. The example method can include receiving, by the computing system from the first or second or third machine-learned sequence processing model, a second language output based at least in part on the second visual chart. The example method can include outputting, by the computing system, the second language output and the second visual chart. In the example method, the first or second or third machine-learned sequence processing model can be a model that was trained by: providing, to the first or second or third machine-learned sequence processing model, one or more training inputs comprising one or more third visual charts; generating, by the first or second or third machine-learned sequence processing model, one or more training outputs based at least in part on the training inputs; and updating, based at least in part on a comparison between the one or more training outputs and third nonvisual data indicative of the one or more third visual charts, the first or second or third machine-learned sequence processing model.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining a first dataset to be analyzed. The example operations can include generating, using a first machine-learned sequence processing model, one or more second instructions that are executable to cause the computing system to process the first dataset to generate a visual chart depicting one or more properties of the first dataset and corresponding nonvisual data indicative of the visual chart. The example operations can include executing the one or more second instructions to generate the visual chart and the nonvisual data indicative of the visual chart. The example operations can include providing, to the first machine-learned sequence processing model or a second machine-learned sequence processing model, at least a portion of the nonvisual data. The example operations can include receiving, from the first or second machine-learned sequence processing model, a language output based at least in part on the nonvisual data. The example operations can include outputting the language output and the visual chart.

In the example operations, generating the one or more second instructions can include providing, to the first machine-learned sequence processing model, data indicative of an application programming interface for processing raw data to generate nonvisual specifications of visual charts. In the example operations, generating the one or more second instructions can include receiving, by the computing system from the first machine-learned sequence processing model, the one or more second instructions.

In the example operations, the nonvisual data can include a complete specification of the visual chart in a structured textual data format.

Example aspects of the present disclosure provide one or more example non-transitory computer-readable media storing instructions that are executable by one or more processors to cause a computing system to perform example operations. In some implementations, the example operations can include obtaining a first dataset to be analyzed. The example operations can include generating, using a first machine-learned sequence processing model, one or more second instructions that are executable to cause the computing system to process the first dataset to generate a visual chart depicting one or more properties of the first dataset and corresponding nonvisual data indicative of the visual chart. The example operations can include executing the one or more second instructions to generate the visual chart and the nonvisual data indicative of a visual chart. The example operations can include providing, to the first machine-learned sequence processing model or a second machine-learned sequence processing model, at least a portion of the nonvisual data. The example operations can include receiving, from the first or second machine-learned sequence processing model, a language output based at least in part on the nonvisual data. The example operations can include outputting the language output and the visual chart.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for chart processing using nonvisual chart data according to example implementations of aspects of the present disclosure;

FIG. 2 is a block diagram of an example system for obtaining nonvisual chart data according to example implementations of aspects of the present disclosure;

FIG. 3 is a block diagram of an example system for generating nonvisual chart data according to example implementations of aspects of the present disclosure;

FIG. 4 is a block diagram of an example system for machine-learned action selection according to example implementations of aspects of the present disclosure;

FIG. 5 is a block diagram of an example system for subsampling nonvisual chart data according to example implementations of aspects of the present disclosure;

FIG. 6 is a block diagram of an example system for training a machine-learned chart processing model according to example implementations of aspects of the present disclosure;

FIG. 7 is a flow chart diagram of an example method for chart processing using nonvisual chart data according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

Generally, the present disclosure is directed to systems and methods for machine-learned analysis of visual charts and related data. More particularly, systems and methods according to some aspects of the present disclosure can enhance a machine-learned model's understanding of a visual chart by providing the machine-learned model with nonvisual data indicative of the visual chart (e.g., alone or in combination with a visual depiction of the visual chart, etc.). For example, a computing system can provide nonvisual chart data to a machine-learned model (e.g., language model, etc.), and the machine-learned model can analyze the chart based at least in part on nonvisual chart data. For example, in some instances, a language model can generate, based at least in part on nonvisual chart data, a natural language output comprising insights about the visual chart or about underlying data described by the chart.

In some instances, nonvisual chart data can include a complete or partial description of a visual chart in a structured data format, such as a structured textual data format (e.g., JavaScript Object Notation (JSON) format, eXtensible Markup Language (XML) format, etc.). For example, in some instances, nonvisual chart data can include JSON-structured data describing one or more properties of a visual chart, such as a type of the visual chart (e.g., pie chart, bar chart, scatterplot, etc.); axis names or axis tick mark values for axes of the visual chart; datapoint values or coordinates (e.g., x coordinate or y coordinate of a scatterplot datapoint; magnitude of a bar chart bar or pie chart slice; etc.); or other data associated with the visual chart.

In some instances, nonvisual chart data can include data generated by the computing system based on raw data to be analyzed. As a non-limiting illustrative example, a computing system can receive, from a user, a request to analyze a raw dataset identified or provided by the user. The computing system can process the raw data to generate both a visual chart and nonvisual data indicative of the visual chart. The computing system can provide, to a machine-learned model, all or part of the nonvisual data indicative of the visual chart. Based on the nonvisual chart data, the machine-learned model can generate a language output (e.g., chart analysis output, etc.). The computing system can provide, to the user, the language output and the visual chart.

In some instances, a computing system can execute computer-executable code generated by a machine-learned code generation model. For example, in some instances, generating nonvisual chart data can include obtaining raw data to be analyzed; generating, using a machine-learned code generation model, computer code configured to process the raw data to generate both a visual chart and nonvisual chart data indicative of the visual chart; and executing the generated code to obtain the nonvisual chart data. In some instances, a computing system can configure (e.g., train, prompt, etc.) a machine-learned model to output code that generates nonvisual chart data by providing the model (e.g., during training, at inference time, etc.) with data indicative of an application programming interface (API) for processing raw data to generate nonvisual chart data (e.g., nonvisual specifications of visual charts, etc.). In some instances, a machine-learned model used to generate code can be the same model or a different model compared to a machine-learned model used to analyze nonvisual chart data.

In some instances, a computing system can include a machine-learned agent configured to independently select actions for the computing system to perform. For example, in some instances, a computing system can receive an input (e.g., action request, data analysis request, etc.) from a user, and can provide the input to a machine-learned agent (e.g., along with other input context such as a system prompt, API data, etc.). Based on the input, the machine-learned agent can select a first action to be executed by the computing system. The computing system can execute the first action, and can provide one or more results of the action to the machine-learned agent. Based on the result(s), the machine-learned agent can select a second action to be executed; the computing system can provide result(s) of the second action to the machine-learned agent; and so on until the machine-learned agent selects a final action (e.g., outputting a final output to a user). In some instances, actions available for selection can include code generation or code execution actions; tool use actions (e.g., API tool use actions); user output actions; intermediate machine-learned inference actions; or other appropriate actions. In some instances, a computing system can configure (e.g., train, prompt, etc.) a machine-learned agent to perform action selections by providing (e.g., during training, as input context during inference, etc.) the machine-learned agent with data indicative of a set of available actions. In some instances, a machine-learned agent configured to select an action can include a machine-learned model that is the same as or different from a machine-learned model used to analyze nonvisual chart data; generate code; or perform another machine-learned action.

In some instances, a computing system can subsample nonvisual chart data or action result data, and can provide only a subset of the nonvisual chart data or action result data to a machine-learned model (e.g., chart analysis model, machine-learned agent, etc.). For example, in some instances, a computing system can compare a size of nonvisual chart data (e.g., nonvisual data indicative of a scatterplot, etc.) to a threshold, such as a predetermined threshold indicative of a maximum dataset size that the machine-learned model can process reliably or accurately (e.g., according to test data; based on a performance quality threshold; etc.). If the size of the nonvisual chart data is smaller than the threshold, the computing system can provide all of the nonvisual chart data to the machine-learned model. In contrast, if the size of the nonvisual chart data is greater than the threshold, the computing system can subsample the nonvisual chart data to generate a subset of nonvisual chart data that is smaller than the maximum size threshold. In some instances, the computing system can sample the subset using one or more techniques described below for ensuring that one or more statistical properties (e.g., minima, maxima, mean, standard deviations, cluster properties, etc.) of the subset are similar to (e.g., same as, etc.) corresponding statistical properties of the full set of nonvisual chart data.

Systems and methods according to some aspects of the present disclosure can provide a variety of technical effects and benefits, such as improvements to computing technology (e.g., machine learning technology, data analysis technology, visual chart analysis technology, etc.). For example, in some instances, systems and methods according to some aspects of the present disclosure can provide improved technical performance (e.g., accuracy, fluency, understanding, etc.) of machine-learned chart processing operations (e.g., machine-learned natural language analysis of chart data, etc.) compared to some alternative implementations. As another example, in some instances, systems and methods according to some aspects of the present disclosure can provide similar (e.g., same, etc.) technical performance at a reduced computational cost (e.g., electricity cost, processor usage, memory usage, etc.) compared to some alternative implementations.

In some instances, systems and methods according to some aspects of the present disclosure can provide improved technical performance (e.g., accuracy, understanding, human-rated output quality, etc.) of machine-learned chart processing operations (e.g., machine-learned natural language analysis of chart data, etc.) compared to some alternative implementations. For example, in some experiments according to example aspects of the present disclosure, systems and methods according to some aspects of the present disclosure were compared to some alternative implementations. In the example experiments, machine-learned inference outputs generated using JSON-structured nonvisual chart data were compared to machine-learned inference outputs generated using visual chart image data using side-by-side comparisons by human raters. In the example experiments, inference outputs generated using JSON-structured data were preferred more than eight times more often than inference outputs generated using only image data.

In some instances, systems and methods according to some aspects of the present disclosure can provide similar (e.g., same, etc.) technical performance at a reduced computational cost (e.g., electricity cost, processor usage, memory usage, etc.) compared to some alternative implementations. For example, in some instances, systems that can provide improved technical performance (e.g., accuracy, output quality, etc.) at a given computational cost can be adapted to provide a given technical performance at reduced computational cost compared to some alternative implementations. For example, in some instances, increasing a number of parameters of a machine-learned model can improve a technical performance (e.g., accuracy, etc.) of the machine-learned model while also increasing a computational cost of the machine-learned model. Conversely, in some instances, decreasing a number of parameters of a machine-learned model can reduce a computational cost (e.g., electricity cost, memory cost, processor usage, etc.) of inference using the machine-learned model, at the cost of a reduction in technical performance. For at least this reason, systems and methods that can provide improved technical performance for a given model size can be adapted to provide a given technical performance at reduced computational cost by reducing a number of parameters of the model or otherwise reducing a computational complexity of the model. Thus, systems and methods according to some aspects of the present disclosure can improve the functioning of a computing system by enabling the computing system to perform a given computing operation (e.g., machine-learned inference at a given quality level, etc.) at a reduced computational cost compared to some alternative implementations.

Various example implementations are described herein with respect to the accompanying Figures.

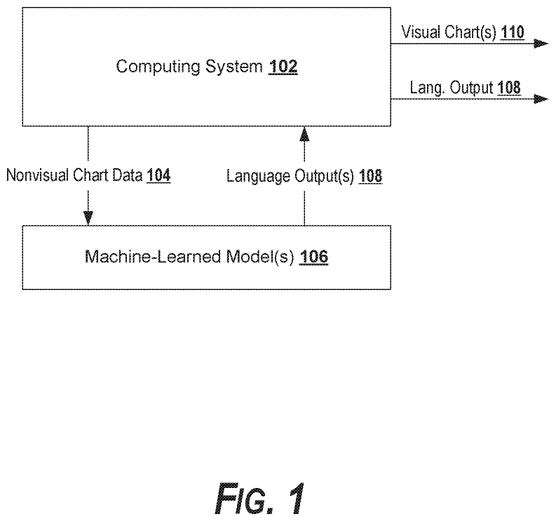

FIG. 1 is a block diagram of an example system for chart processing using nonvisual chart data according to example implementations of aspects of the present disclosure. A computing system 102 can provide nonvisual chart data 104 to one or more machine-learned models 106. Based at least in part on the nonvisual chart data 104, the machine-learned model(s) 106 can generate one or more language outputs 108. The computing system 102 can output the language output(s) 108 and one or more visual charts 110 associated with the nonvisual chart data 104.

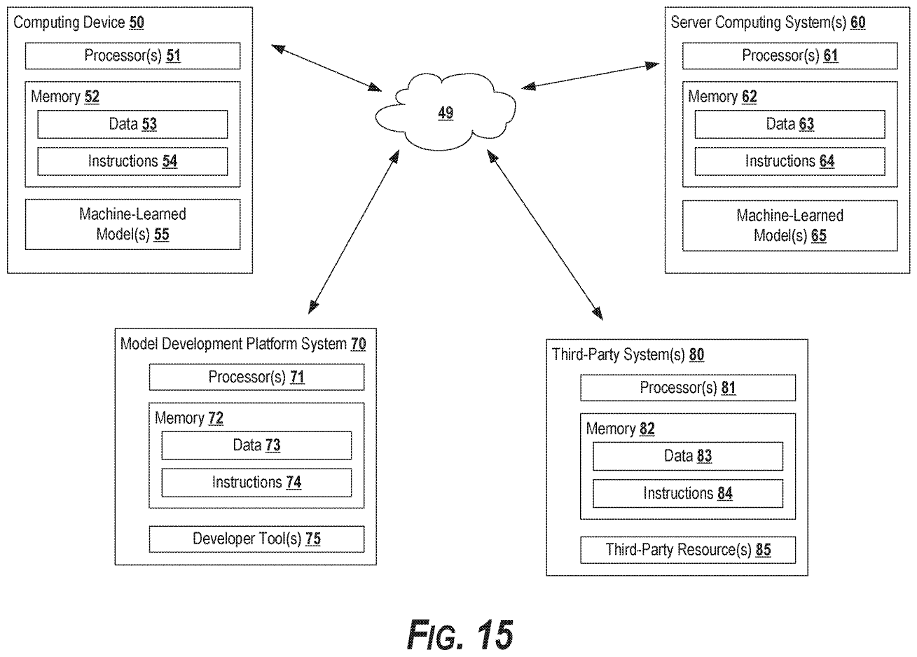

A computing system 102 can be or include one or more software, firmware, or hardware components configured to provide nonvisual chart data 104 to machine-learned model(s) 106. In some instances, the computing system 102 can be, comprise, be comprised by, or share one or more properties with a computing device or system described below with respect to FIGS. 15-17 (e.g., computing device 50, third-party system 80, computing device 98, computing device 99, etc.).

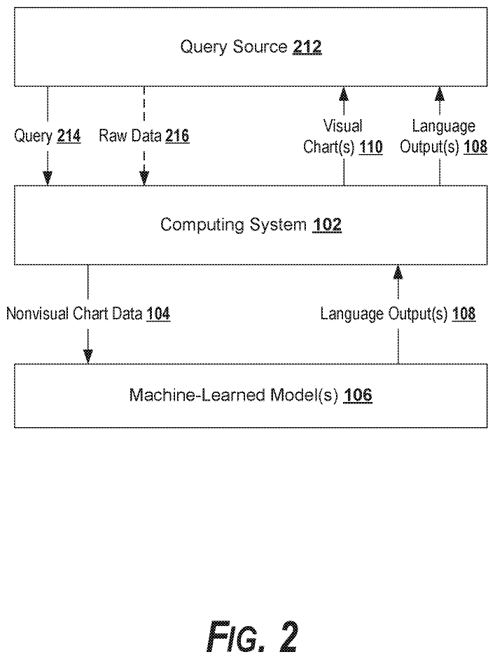

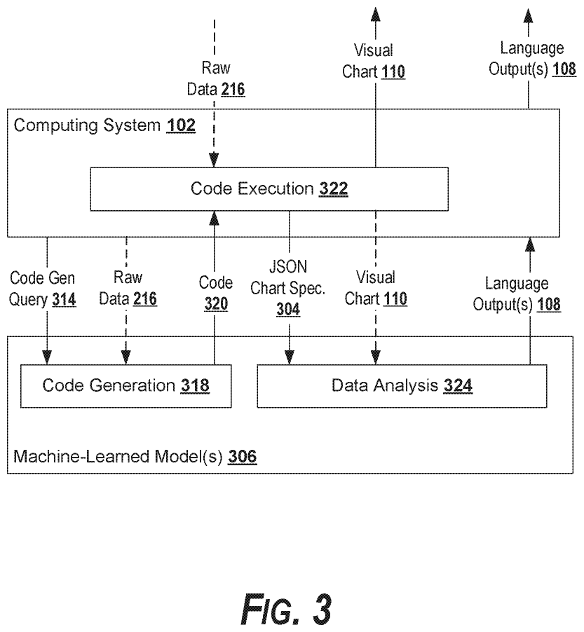

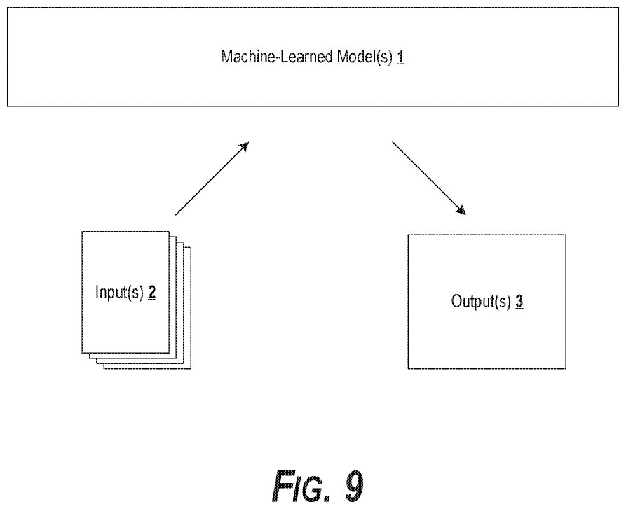

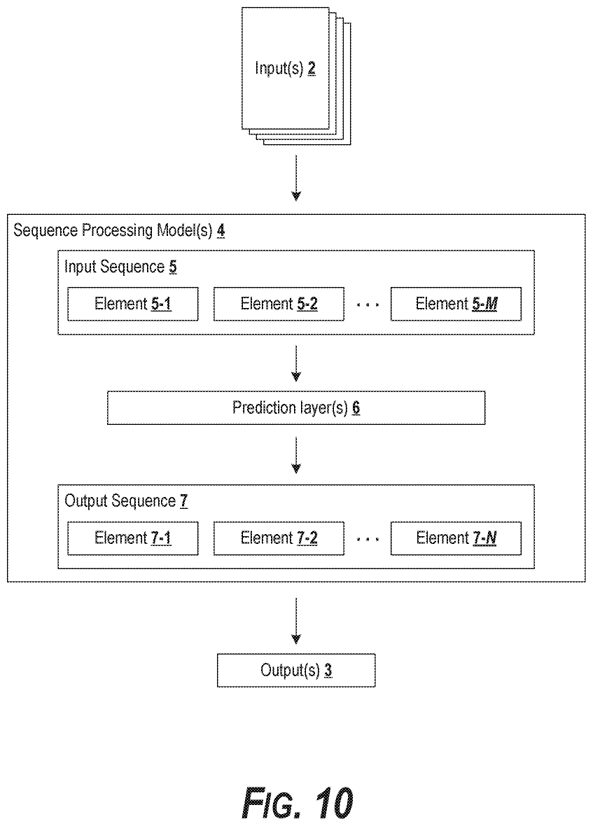

Nonvisual chart data 104 can generally include or otherwise represent various types of data. Nonvisual chart data 104 can include one type or many different types of data. Example data types for nonvisual chart data 104 can include, for example, various data types described below with respect to FIGS. 9-10 and inputs 2, such as language data (e.g., natural language data such as text or speech data, programming language data, etc.), sequence data (e.g., language sequence, time series, etc.), or another data type. In some instances, nonvisual chart data 104 can include data indicative of a visual chart 110, such as a complete or partial description of a visual chart 110 in a structured format (e.g., structured textual format such as JavaScript Object Notation (JSON), eXtensible Markup Language (XML), or the like). Further details of some example structured formats for representing visual chart(s) 110 using nonvisual chart data 104 are provided below with respect to FIG. 3. In some instances, nonvisual chart data 104 or a corresponding visual chart 110 can include chart data generated (e.g., by the computing system 102, etc.) based at least in part on raw data to be analyzed, such as raw data received (e.g., from a user, from another computing device, etc.), retrieved (e.g., from a storage device or other computer-readable media, from a web server or other device, etc.), collected (e.g., using one or more sensors, etc.), generated, or otherwise obtained by the computing system 102. Further details of some example implementations for generating nonvisual chart data 104 from raw data are provided below with respect to FIGS. 2 and 3.

In some instances, a computing system 102 can provide nonvisual chart data 104 to a machine-learned model 106, either alone or in combination with additional input context, such as in-context learning content (e.g., instruction content, system prompt content, few-shot example content, chain-of-thought example content, action selection or tool use content such as application programming interface (API) documentation, etc.), additional data to be analyzed (e.g., additional nonvisual chart data 104 associated with additional visual chart(s) 110; additional raw data; additional language data; etc.), query content such as a user query requesting analysis of data identified or provided by the user, or other additional input context.

The machine-learned model(s) 106 can include one or more machine-learned models. The machine-learned model(s) 106 can include various model architectures, such as various neural network model architectures. An example model architecture for a machine-learned model 106 can include a sequence processing model architecture (e.g., a transformer model). For example, a machine-learned model 106 can be configured to receive an input sequence and generate an output sequence. For instance, a machine-learned model 106 can be configured to generate an output sequence where elements of the output sequence are predicted based on the elements of the input sequence. In some instances, a machine-learned model 106 can include a model architecture having an attention mechanism (e.g., self-attention). In some instances, the machine-learned model 106 can be a pre-trained model (e.g., pretrained using large-scale unsupervised learning). In some instances, the machine-learned model 106 can be fine-tuned over one or more fine-tuning datasets, such as a fine-tuning dataset associated with one or more specialized generation tasks.

In some instances, the machine-learned model(s) 106 can include one or more multimodal machine-learned models. In some instances, a multimodal machine-learned model 106 can include a multimodal machine-learned model configured to receive, as input, one or more of: text data (e.g., natural language text data, computer code data, structured text data such as JSON-structured text data, etc.), natural language data (e.g., text data, audio speech data, etc.), image data, or other input type. In some instances, a multimodal machine-learned model 106 can include a multimodal machine-learned model configured to provide, as output, one or more of: text data (e.g., natural language text data, computer code data, structured text data such as JSON-structured text data, etc.), natural language data (e.g., text data, speech data, etc.), or other input type. As a non-limiting illustrative example, a multimodal machine-learned model 106 can include a multimodal sequence processing model (e.g., Google Gemini, etc.) configured to receive, as input, one or both of text data and image data; and provide, as output, one or both of text data and image data (e.g., wherein a data type of a generated output can depend at least in part on an input context, etc.).

In some instances, the machine-learned model(s) 106 can include one model or multiple models. As a non-limiting illustrative example, in some implementations a multimodal machine-learned model can generate (e.g., based on image input data, etc.) text input(s) (e.g., natural language text input(s), etc.) to be provided to a second machine-learned model 106 configured to process only text inputs. As another example, in some implementations, a single machine-learned model 106 (e.g., multimodal machine-learned model 106, text-only or other unimodal machine-learned model 106, etc.) can process nonvisual chart data 104 to generate language output(s) 108, without the use of any additional machine-learned model(s) 106. In some instances, a single machine-learned model 106 can also perform additional tasks or functions, such as one or more functions described herein with respect to FIGS. 2-5.

In some implementations involving two or more machine-learned models 106, the two or more machine-learned models 106 can have one or more parameter(s) or layer(s) that are the same as or different from each other. As a non-limiting illustrative example, in some instances, a computing system 102 can provide, to a first machine-learned model 106, first in-context learning content to cause the first machine-learned model 106 to perform a first function; and provide, to a second machine-learned model 106 having a set of parameters (e.g., weights, layers, etc.) that is identical to a set of parameters of the first machine-learned model 106, second in-context learning content to cause the second machine-learned model 106 to perform a second function. As another example, in some instances, a first machine-learned model 106 and second machine-learned model 106 can have a set of shared layers (e.g., pretrained layers, etc.) that are identical between the first and second machine-learned model 106, and one or more of the first and second machine-learned model 106 can have one or more additional layers (e.g., fine-tuned layers, adapter layers, etc.) that are not identically shared between the first and second machine-learned model 106. Other examples are possible.

In some instances, a machine-learned model 106 can be configured (e.g., prompted, trained, etc.) to perform chart analysis, chart generation, or data analysis (e.g., natural language data analysis, etc.). In some instances, configuring a machine-learned model 106 for chart analysis can include providing the machine-learned model 106 with data (e.g., training data, in-context learning data, etc.) to cause the machine-learned model 106 to perform chart analysis. Example data to cause the machine-learned model 106 to perform chart analysis can include training data, such as training inputs comprising a chart analysis task, training updates based on a comparison between a training output generated by the machine-learned model 106 and a ground truth output, etc.; in-context learning data, such as system prompt data or instruction data instructing the machine-learned model 106 to perform chart analysis, few-shot or chain-of-thought example content comprising one or more example chart analysis tasks (e.g., example input-output pairs, example input-action-output triplets, example input-reasoning-output triplets, etc.), or other in-context learning content.

A language output 108 can generally include or otherwise represent various types of data. A language output 108 can include one type or many different types of data. A language output 108 can include one or more data types that are similar to (e.g., same as) or different from one or more data types of nonvisual chart data 104. Example data types for a language output 108 can include, for example, text data (e.g., natural language text data, computer code data, etc.), audio data (e.g., natural language speech data), visual data, or another data type. In some instances, language output(s) 108 can include only language data, or can include language data in combination with one or more other data types (e.g., visual data, audio data, etc.).

In some instances, a language output 108 can include one or more chart analysis insights, such as natural language data indicative of one or more statistical properties (e.g., averages, minima, maxima, correlations, trends, etc.) of data associated with the visual chart 110, natural language data indicative of other insights (e.g., historical insights, economic insights, action suggestions, benchmark comparisons, etc.) that may be related to one or more properties of the visual chart 110. In some instances, a language output 108 can include one or more analysis outputs requested by a user (e.g., “Please review this sales data and identify conditions that have the biggest impact on a prospective customer's likelihood of buying item X.”, etc.). In some instances, configuring a machine-learned model 106 to output language outputs 108 comprising analysis requested by a user can include providing (e.g., during training as training input-ground truth output pairs, during inference as few-shot example input-output pairs, etc.) the machine-learned model 106 with data indicative of one or more data pairs correlating a user request with a corresponding language output responsive to the request.

A visual chart 110 can generally include or otherwise represent various types of data. A visual chart 110 can include one type or many different types of data. A visual chart 110 can include one or more data types that are similar to (e.g., same as) or different from one or more data types of nonvisual chart data 104. Example data types for a visual chart 110 can include, for example, image data (e.g., JPEG, PNG, bitmap, etc.), video data (e.g., animated chart data, etc.), presentation data (e.g., Google Slides data, etc.), markup language data (e.g., hypertext markup language (HTML), etc.) or computer code data configured to cause a computing system or component thereof (e.g., web browser, Python package, etc.) to display a visual chart 110; or other data type.

A visual chart 110 can include, for example, a visual image configured to illustrate various kinds of data, such as time series data, numerical data, measurement data, survey data, historical data, factual data, scientific data, economic data, or other data type. In some instances, a visual chart 110 can include a visual image depicting a bar chart, pie chart, scatterplot chart, line chart, graph, bubble chart, waterfall chart, histogram, heat map, three-dimensional chart, infographic, geographic display, interactive display, layered plot, or other visual or multimodal representations of one or more of visual, textual, and numerical information. In some instances, a visual chart 110 can include a visual description of one or more properties of raw data to be analyzed, such as raw data provided by a user or otherwise identified by a user. Further detail of some example systems for generating a visual chart 110 based on raw data to be analyzed are provided below with respect to FIGS. 2-3.

FIG. 2 is a block diagram of an example system for obtaining nonvisual chart data according to example implementations of aspects of the present disclosure. A query source 212 can provide, to a computing system 102, a query 214 requesting analysis of raw data 216 identified by the query source 212. Based at least in part on the raw data 216, the computing system 102 can obtain (e.g., generate, etc.) nonvisual chart data 104 indicative of a visual chart 110 illustrating one or more properties of the raw data 216. Based at least in part on the nonvisual chart data 104, the machine-learned model(s) 106 can generate one or more language outputs 108. The computing system 102 can output, to the query source 212, the language output(s) 108 and one or more visual charts 110 associated with the nonvisual chart data 104.

A query source 212 can include any source from which a query 214 can be received, such as a user; a computing device (e.g., smartphone, laptop computer, desktop computer, onboard computing device of a vehicle or robot, etc.); a communication device; or other query source.

A query 214 can generally include or otherwise represent various types of data. A query 214 can include one type or many different types of data. Example data types for a query 214 can include, for example, any data type described below with respect to FIGS. 9-10 and inputs 2, such as language data (e.g., natural language data such as text or speech data, programming language data, etc.), sequence data (e.g., language sequence, time series, etc.), image data, audio data, video data, or another data type.

In some instances, a query 214 can include natural language content indicative of a requested analysis of data, such as data identified in the query 214. In some instances, data identified in a query 214 can include raw data 216 included directly as part of the query 214; data identifying a location of the raw data 216 to be analyzed, such as filename data, database location data, memory location data; data providing a means to retrieve the raw data 216 to be analyzed, such as computer code comprising a database query; or other data identification. In some instances, data identified in a query 214 can include data identified indirectly or implicitly, such as data associated with an open-ended question or general question about a topic for which data may be available. As a non-limiting illustrative example, a query 214 comprising a natural language question about basketball may cause a computing system 102 or machine-learned model 106 to retrieve raw data 216 from one or more known sources (e.g., databases, files, websites, APIs, data storage devices, etc.) of basketball-related data; process the raw data 216 to generate one or more visual charts 110 and corresponding nonvisual chart data 104 associated with the visual chart(s) 110; and generate language output(s) 108 based on the nonvisual chart data 104. In some instances, identifying a relevant data source based on a query 214 can include keyword-based data source identification; machine-learned data source identification; or other method of identifying a relevant data source. In some instances, machine-learned data source identification can include providing the query 214 (e.g., alone or in combination with additional input context such as in-context learning content, etc.) to a machine-learned model (e.g., machine-learned model configured to identify data sources based on query 214 inputs, etc.). As another example, in some instances, data source identification can include providing the query 214 to a machine-learned embedding model to generate a machine-learned embedding and retrieving (e.g., from a vector database, etc.), based on the embedding, data indicative of a relevant data source (e.g., based on a distance metric between an embedding of the query 214 and an embedding of a description of the data source, etc.). As another example, in some instances, data source identification can include a web search (e.g., non-machine-learned keyword-based web search, web search using keywords output by a machine-learned model based on a query 214, etc.). Other examples are possible.

Raw data 216 can generally include or otherwise represent various types of data. Raw data 216 can include one type or many different types of data. Raw data 216 can include one or more data types that are similar to (e.g., same as) or different from one or more data types of nonvisual chart data 104. Example data types for raw data 216 can include, for example, any data type described below with respect to FIGS. 9-10 and inputs 2, such as numerical data (e.g., measurement values or other numerical datapoint values, numerical identifier data such as datapoint identifiers, etc.), text data (e.g., language data, text-based labels associated with numerical data, etc.), or another data type. In some instances, raw data 216 can include raw data to be analyzed or raw data from which a chart can be generated. As a non-limiting illustrative example, raw data 216 can include a file (e.g., spreadsheet file, comma-separated value file, etc.) or other data structure (e.g., database table, etc.) storing a dataset comprising a small or large number (e.g., dozens, thousands, millions, etc.) of data points, and nonvisual chart data 104 can include processed data indicative of a chart describing one or more properties of the dataset. Further details of example nonvisual chart data 104 that can be generated from raw data 216 are provided below with respect to FIG. 3 and JSON-structured chart specification(s) 304.

In some instances, a computing system 102 can generate nonvisual chart data 104 based on raw data 216. In some instances, generating nonvisual chart data 104 can also be based in part on one or more other data values, such as a query 214 or other data. In some instances, generating nonvisual chart data 104 can include one or more machine-learned operations or non-machine-learned operations. In some instances, generating nonvisual chart data 104 and visual chart(s) 110 can include one or more statistical processing operations, such as clustering; identifying statistical properties such as averages, minima, maxima, or the like; correlation analysis; or other statistical processing operations. In some instances, generating nonvisual chart data 104 and visual chart(s) 110 can include one or more chart processing operations, such as binning, sorting, counting, or other process for generating one or more known chart types (e.g., chart types described above with respect to FIG. 1 and visual chart(s) 110, etc.). In some instances, generating nonvisual chart data 104 and visual chart data 110 can include a combination of machine-learned and non-machine-learned operations, such as machine-learned selection (e.g., based at least in part on a query 214, etc.) of one or more parameters of a chart generation process, combined with non-machine-learned chart generation (e.g., using a chart generation API, such as a Python vega-altair or matplotlib API, etc.) according to the selected parameters. Further details of an example system for generating nonvisual chart data 104 and visual charts 110 based on raw data 216 are provided below with respect to FIG. 3.

FIG. 3 is a block diagram of an example system for generating nonvisual chart data according to example implementations of aspects of the present disclosure. A computing system 102 can provide a code generation query 314 (e.g., alone or in combination with other data such as raw data 216, etc.) to a code generation model 318. Based at least in part on the code generation query 314, the code generation model 318 can generate code 320 for processing raw data 216 to generate a visual chart 110 and corresponding nonvisual chart data 104, such as a JavaScript Object Notation (JSON)-structured chart specification 304 of the visual chart 110. A code execution module 322 of a computing system 102 can execute the code 320 to generate nonvisual chart data 104 (e.g., JSON-structured chart specification data 304, etc.) and a visual chart 110, and the computing system 102 can provide the nonvisual chart data 104 to a data analysis model 324 (e.g., alone or in combination with other data, such as visual data comprising the visual chart 110, etc.). Based at least in part on the nonvisual chart data 104, the data analysis model 324 can generate one or more language outputs 108. The computing system 102 can output the language output(s) 108 and the visual chart 110.

In some instances, a JSON-structured chart specification 304 can be, comprise, be comprised by, or otherwise share one or more properties with nonvisual chart data 104. For example, in some instances, a JSON-structured chart specification 304 can have any property described herein with respect to nonvisual chart data 104, and vice versa.

In some instances, a JSON-structured chart specification 304 can include a complete specification of a visual chart 110, such as a description sufficient to generate a visual chart 110 image based solely on the JSON-structured chart specification 304. In some instances, a JSON-structured chart specification 304 can include various data indicative of various contents of a chart. Example data of a JSON-structured chart specification 304 can include numerical data indicative of one or more numerical properties of one or more (e.g., all, etc.) chart object data items (e.g., chart axes, datapoints of a scatterplot, lines of a line graph, bars of a histogram or bar chart, etc.), such as axis tick mark locations, coordinate(s) on one or more axes of each respective chart object data item of a plurality of items, count data or percentage data associated with a histogram or pie chart, numerical line data indicative of a location of one or more lines of a line chart, size, shape, or location data of one or more visual chart objects, or other numerical data. As another example, in some instances, nonvisual chart data 104 can include nonnumerical data, such as text or language data indicative of one or more labels (e.g., chart title, axis label(s), datapoint labels, etc.) associated with a visual chart 110; metadata associated with the chart (e.g., chart font, color scheme, creation date, last updated timestamp, etc.) or metadata associated with chart objects of the chart; image data such as identifier or filename data associated with one or more images (e.g., map images, icons, emojis, photos, etc.) to be included in a visual chart 110; or other relevant chart data. In some instances, a JSON-structured chart specification 304 can include chart data that may be smaller or more concise than corresponding raw data 216 from which the JSON-structured chart specification 304 was generated.

In some instances, a JSON-structured chart specification 304 can include data in a JavaScript Object Notation (JSON) format. In some instances, a JSON-structured chart specification 304 can include data structured according to a chart description grammar (e.g., vega-lite, etc.), such as a chart description grammar associated with a tool (e.g., API, software module, etc.) for generating visual charts 110 from JSON-structured chart specifications 304 (e.g., vega-altair, etc.).

In some instances, machine-learned model(s) 306 can be, comprise, be comprised by, or otherwise share one or more properties with machine-learned model(s) 106. For example, in some instances, machine-learned model(s) 306 can have any property described herein with respect to machine-learned model(s) 106, and vice versa. For example, in some instances, machine-learned model(s) 306 can include one model or multiple models. As another example, in some instances, a single machine-learned model 306 configured to perform both code generation 318 and data analysis 324 can include a single machine-learned model 306 prompted with a single system prompt or single set of in-context learning content (e.g., combined system prompt comprising both code generation instruction content and data analysis instruction content, etc.), or two instances of a single machine-learned model 306 prompted with two different sets of in-context learning content (e.g., first system prompt comprising code generation instruction content; second system prompt comprising data analysis instruction content; etc.). Other examples are possible.

In some instances, a code generation model 318 can be, comprise, be comprised by, or otherwise share one or more properties with a machine-learned model 106. For example, in some instances, a code generation model 318 can have any property described herein with respect to a machine-learned model 106, and vice versa.

In some instances, a code generation model 318 can include a machine-learned model that has been configured (e.g., prompted, trained, etc.) to generate computer-executable code 320 based on one or more inputs, such as one or more code generation queries 314 or other input data (e.g., raw data 216; in-context learning content such as system prompt, few-shot example content, instruction content, etc.; or other input data). In some instances, configuring a code generation model 318 to generate code can include providing (e.g., during training, at inference time as input context, etc.) the code generation model 318 with learning data (e.g., training data, in-context learning data, etc.) indicative of computer code or indicative of one or more computer-executable instructions, such as application programming interface (API) documentation data (e.g., function signatures, docstrings, etc.), input-output tuple data (e.g., few-shot examples comprising input-output pairs or input-action-output tuples, training data comprising training input-ground truth output pairs, etc.) correlating example input(s) (e.g., example code generation query 314 inputs, etc.) to example computer-executable instructions for performing one or more actions associated with the example input(s) (e.g., actions requested by an example natural language input, intermediate actions determined by a machine-learned agent for fulfilling a request associated with an example input, etc.), instruction data comprising instructions for generating code based on API documentation data or few-shot example data, system prompt data, or other data.

In some instances, configuring a code generation model 318 to generate code 320 can include providing the code generation model 318 with learning data (e.g., training data, in-context learning content, etc.) indicative of a component (e.g., API, package, library, software module, code module, etc.) for generating nonvisual data 104, visual chart(s) 110, or JSON-structured chart specification(s) 304 based on raw data 216. For example, in some instances, configuring a code generation model 318 to generate code 320 for generating nonvisual chart data 104 can include providing the code generation model 318 with data indicative of an API (e.g., vega-altair API, etc.) for generating JSON-structured chart specification(s) 304 and corresponding visual charts 110. In some instances, configuring a code generation model 318 to generate code 320 for generating nonvisual chart data 104 can include configuring the code generation model 318 to avoid using component(s) (e.g., APIs, etc.) configured to generate visual charts 110 without corresponding nonvisual chart data 104. For example, in some instances, configuring a code generation model 318 to generate code 320 for generating nonvisual chart data 104 can include omitting, from learning data (e.g., training data, in-context learning content, etc.) provided to the code generation model 318, any data associated with one or more APIs (e.g., matplotlib, etc.) for generating visual charts 110 without generating corresponding nonvisual chart data 104; expressly instructing the code generation model 318 to avoid one or more APIs (e.g., matplotlib, etc.) for generating visual charts 110 without generating corresponding nonvisual chart data 104; or the like.

Code 320 can generally include or otherwise represent various types of data. Code 320 can include one type or many different types of data. Code 320 can include one or more data types that are similar to (e.g., same as) or different from one or more data types of a code generation query 314. Example data types for code 320 can include, for example, text data, language data (e.g., language data associated with a computer programming language such as Python, etc.), source code data, object code data (e.g., machine code, assembly language, executable binary code, etc.), bytecode data, or other code data. In some instances, code 320 can include one or more computer-readable instructions that, when executed by one or more processors of a computing device, cause the processor(s) to perform operations, such as various operations described herein with respect to FIGS. 1-7 (e.g., data analysis operations, data retrieval operations, chart generation operations, machine learning operations, etc.).

A code execution module 322 can be or include one or more software, firmware, or hardware components configured to execute code 320 obtained from a code generation model 318. In some instances, the code execution module 322 can be, comprise, be comprised by, or share one or more properties with a computing device or system described below with respect to FIGS. 15-17 (e.g., computing device 50, third-party system 80, computing device 98, computing device 99, etc.).

In some instances, a data analysis model 324 can be, comprise, be comprised by, or otherwise share one or more properties with a machine-learned model 106. For example, in some instances, a data analysis model 324 can have any property described herein with respect to a machine-learned model 106, and vice versa. In some instances, a data analysis model 324 can be the same model or a different model from a code generation model 318. In some instances, a data analysis model 324 can share or not share one or more parameters with a code generation model. In some instances, a data analysis model 324 can include a model that has been provided with similar (e.g., same, etc.) in-context learning content (e.g., system prompt, instruction content, few-shot example content, etc.) or different in-context learning content compared to a code generation model 318.

In some instances, a data analysis model 324 can include a machine-learned model 306 configured (e.g., trained, prompted, etc.) to generate language outputs 108 (e.g., data analysis language outputs 108, language outputs 108 comprising natural language data insights associated with a visual chart 110 or JSON-structured chart specification 304, etc.) based at least in part on nonvisual chart data 104 (e.g., JSON-structured chart specification 304 data, etc.). In some instances, configuring a data analysis model 324 can include providing (e.g., at training time, at inference time, etc.) the data analysis model with learning data (e.g., training updates, in-context learning content, etc.) configured to cause the data analysis model 324 to generate natural language data analysis insights based on nonvisual chart data 104, such as instruction content, system prompt content, example input-output tuples (e.g., few-shot example input-output pairs; example input-action-output or input-reasoning-output tuples; training examples comprising a training input and corresponding ground truth output; etc.). In some instances, an input-output tuple can include one or more example inputs (e.g., example natural language input indicative of a requested data analysis, example JSON-structured chart specification 304, etc.) and a corresponding example output responsive to the example input (e.g., language data such as human-written natural language data analysis insight, etc.).

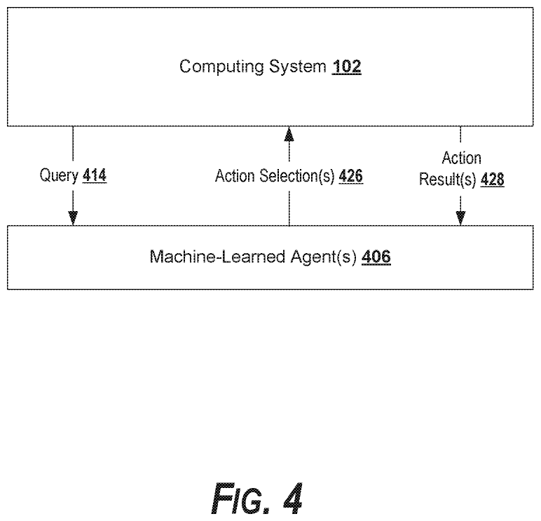

FIG. 4 is a block diagram of an example system for machine-learned action selection according to example implementations of aspects of the present disclosure. A computing system 102 can provide one or more queries 414 to one or more machine-learned agents 406. The agent(s) 406 can output, based at least in part on the query 414, one or more action selections 426. Based at least in part on the action selection(s) 426, the computing system 102 can perform one or more actions, and can provide one or more action result(s) 428 to the machine-learned agent(s) 406. In some instances, the process can be repeated one or more times, such that a computing system 102 may perform two or more actions identified by two or more action selections 426 in response to one query. For example, in some instances, a computing system 102 can provide first action result(s) 428 associated with a first action to a machine-learned agent 406; the machine-learned agent 406 can output a second action selection 426 based on the first action result(s) 428; the computing system 102 can execute the second action selection 426 and provide second action result(s) 428 to the machine-learned agent 406; and so on for a plurality of iterations (e.g., wherein some action selection(s) 426 of a later iteration may be based at least in part on action result(s) of a previous iteration, etc.) until the machine-learned agent 406 selects a final action (e.g., outputting a final output to a query source 212, etc.).

In some instances, a machine-learned agent 406 can be, comprise, be comprised by, or otherwise share one or more properties with a machine-learned model 106. For example, in some instances, a machine-learned agent 406 can have any property described herein with respect to a machine-learned model 106, and vice versa. In some instances, a machine-learned agent 406 can be the same model or a different model as one or more of a code generation model 318, data analysis model 324, or other machine-learned model 106. As a non-limiting illustrative example, in some instances, a machine-learned agent 406 can generate code 320 directly, and can provide the code 320 to a computing system 102 as an action selection 426 (e.g., in addition to other action selection(s) 426 that may not comprise code 320, etc.). As another non-limiting illustrative example, in other instances, a machine-learned agent 406 may select a code generation action to be performed by a separate code generation model 318, which may be a separate model having weights that are different from weights of a machine-learned agent 406, or a model with similar (e.g., same, etc.) weights that has been prompted with in-context learning content to cause the code generation model 318 to generate code. Other examples are possible.

In some instances, a machine-learned agent 406 can include a machine-learned model 106 that has been configured (e.g., trained, prompted, etc.) to generate one or more action selections 426 based at least in part on one or more of a query 414; action result(s) 428 associated with previous action selection(s) 426; or other input context (e.g., conversational history, system prompt, retrieved data, etc.). In some instances, configuring a machine-learned agent 406 to generation action selection(s) 426 can include providing (e.g., during training as training input(s) or training update(s), during inference as input context, etc.) the machine-learned agent 406 with data indicative of a set of available actions; data indicative of a method for selecting one or more of the available action(s) (e.g., data indicative of a format or structure for selecting a particular action; data indicative of an action name or action identifier for a particular action; API data indicative of a template or format for generating computer code to cause a computing system 102 to perform the action; or the like).

In some instances, a query 414 can be, comprise, be comprised by, or otherwise share one or more properties with a query 214. For example, in some instances, a query 414 can have any property described herein with respect to a query 214, and vice versa. In some instances, a query 414 can include natural language data requesting analysis of a dataset, topic, question, or the like.

In some instances, an action selection 426 can be, comprise, be comprised by, or otherwise share one or more properties with a language output 108, code 320, or other machine-learned model 106 output. For example, in some instances, an action selection 426 can have any property described herein with respect to a language output 108 or code 320, and vice versa. In some instances, an action selection 426 can include computer code that, when executed, causes one or more code execution 322 tools to perform the selected actions, such as one or more API calls associated with an API; computer-executable network requests (e.g., hypertext transfer protocol requests, etc.); or other computer-executable instructions. In some instances, an action selection 426 can include other data indicative of a selected action, such as an action name, action identifier (e.g., numerical identifier, token, etc.), action description, action parameters, or the like. For example, in some instances, a computing system 102 can receive an action selection 426 that does not comprise executable computer code, and can execute one or more operations based on the action selection 426. As a non-limiting illustrative example, a computing system 102 can include glue code configured to receive an action selection 426 comprising an action name; and perform, based on the action selection 426, an action identified by the action name.

In some instances, performing a selected action can include mapping the action selection to corresponding executable code (e.g., corresponding application programming interface (API) call, etc.) and executing the executable code. In some instances, mapping an action selection 426 to executable code can include retrieving corresponding executable code (e.g., corresponding API call, etc.) from a data structure (e.g., database, table, row, column, file, object, etc.) based at least in part on the action selection 426 (e.g., based on an action identifier, etc.). In some instances, mapping the action selection 426 to executable code can include passing the action selection 426 to glue code (e.g., glue code comprising one or more compiler, interpreter, or parser functions, etc.) configured to map action selections 426 to executable actions.

In some instances, an output of a machine-learned agent 406 can be processed to identify and carry out action selections 426. For example, in some instances, a computing system can parse an output of the machine-learned agent 406 (e.g., based on delimiter tags such as “[Execute_Code]:”, “[Output_To_User]:”, or the like), and one or more action selections 426 can be extracted from the parsed output. In some instances, the parsed output can be checked for correctness (e.g., correct syntax, valid tool name, valid tool inputs, etc.). If a valid action selection is detected, a computing system may perform the action or cause another tool to perform the selected action. As a non-limiting illustrative example, in some instances, an action selection 426 can include a first delimiter indicative of an action selection (e.g., “<action>”, etc.) followed by data (e.g., text data, language data, binary data, sequence data, etc.) indicative of a tool selection, action selection, action or tool parameters, inputs to a tool or function, or the like. In some instances, parsing an action selection 426 can include parsing based on the first delimiter (e.g., using a regular expression comprising data indicative of the first delimiter, etc.) to extract an action selection or tool selection output segment; parsing the action/tool selection output segment to extract one or more of an action identifier (e.g., name, etc.) or tool identifier, action or tool parameter(s), and input(s) to a tool or function; and performing a selected action based on the extracted data (e.g., based on a mapping from a tool identifier to an API function; based on a mapping from tool parameters or inputs to corresponding parameters of the API function; etc.).

In some instances, a computing system 102 can perform a selected action directly (e.g., using a code execution 322 tool, etc.), or may provide a signal to cause another tool (e.g., device, system, software module, firmware component, hardware component, etc.) to perform the action. A tool for performing actions can be or include one or more software, firmware, or hardware components configured to perform actions identified in an action selection 426. In some instances, a tool can include one or more API tools having an application programming interface (API) that can be called to invoke the API tool. In some instances, a tool can include a tool that is executed or invoked in another manner, such as a tool comprising glue code configured to receive an action selection 426 output and perform one or more actions identified by the action selection 426. In some instances, an API of an API tool can be called directly by a machine-learned agent 406 (e.g., a machine-learned agent 406 configured to generate code 320, etc.), or by another component (e.g., software, firmware, or hardware component, such as glue code, interpreter, compiler, etc.) based on action selection 426 outputs of the machine-learned agent 406.

An API tool can include, for example, any tool (e.g., hardware tool, software tool, firmware tool, etc.) that can be accessed via an API. For example, in some instances, an API tool can include software (e.g., application, operating system, etc.) installed on a computing system 102 or another device (e.g., mobile device, smartphone, etc.) running the machine-learned agent 406; software available via a network (e.g., internet); hardware devices (e.g., internet-connected hardware devices, Bluetooth-connected hardware devices, etc.); etc. In some instances, a hardware API tool can include a hardware tool connected (e.g., via a network, via a wireless or wired connection, etc.) to a device running the machine-learned agent 406. In some instances, an API tool can include a tool for chart generation or data analysis, such as vega-altair, matplotlib, or another chart generation tool. In some instances, an API tool can include a tool for obtaining (e.g., retrieving, receiving, generating, etc.) data (e.g., raw data 216, etc.) to be charted or otherwise analyzed, such as a data structure (e.g., file system, database such as vector database, etc.), data storage device (e.g., hard disk drive, solid state drive, etc.), data retrieval API, search API (e.g., web search API), website, computing device (e.g., server device configured to provide data in response to one or more hypertext transfer protocol (HTTP) requests, etc.), sensor or other measurement tool, or other data source.

Other example tools are possible. For example, in some instances, a machine-learned agent 406 configured to generate action selection(s) 426 for chart analysis can include a special-purpose data analysis agent or a general-purpose agent configured to perform a variety of actions that may be unrelated to chart analysis. In some instances, example API tools that may be available to a general-purpose machine-learned agent 406 can include a navigation API (e.g., map-related API, global positioning system-related API, etc.); a communication API (e.g., API associated with making phone calls, emails, or text messages such as SMS or MMS; APIs associated with communication applications, such as messaging applications, social media communication applications, etc.); a scheduling API (e.g., calendar, alarm, automated task scheduling, etc.); media player API (e.g., video player such as YouTube, audio player, etc.); shopping API; payment API such as Google Pay; mobile banking API; travel-related API (e.g., flight booking, hotel booking, etc.); or API of any application installed on a mobile device. In some instances, an API tool can include a hardware device such as a Bluetooth-connected lock, gate opener, garage door opener, etc.; an internet-connected doorbell or surveillance camera device; smart home device such as smart TV, smart appliance, lighting devices, thermostats, etc.; or any other API-accessible hardware tool.

In some instances, an example tool available to a machine-learned agent 406 can include a tool (e.g., code generation model 318, data analysis model 324, etc.) configured to perform one or more operations that may include a machine learning component, such as machine-learned code generation or data analysis; image processing (e.g., machine-learned image processing; image generation, visual question answering, visual identification such as facial recognition, image captioning, etc.), audio processing (e.g., machine-learned speech processing; audio generation such as speech or music generation, speech-to-text or text-to-speech processing, audio identification such as voice identification, etc.), video processing (e.g., video generation, etc.), sequence processing (e.g., natural language sequence generation, natural language translation, question answering, computer code generation, etc.), robotics (e.g., robotic systems comprising machine-learned agent(s) configured to control physical manipulation tools, etc.), mobile digital assistants (e.g., smart phone assistants configured to perform communication actions, navigation actions, calendar actions, smart appliance control actions, etc.) or other action type. Other tool types are possible.

In some instances, an action selection 426 can include a selection of one or more code generation actions, one or more code execution actions, one or more output actions, or other action type. For example, in some instances, an action selection 426 can include one or more computer-readable instructions (e.g., code 320, etc.) generated by the machine-learned agent 406, along with data (e.g., delimiter data, etc.) indicative of a selection of a code execution action (e.g., “<begin_code>”, “{EndOfCode}”, “[Act]: Execute”, etc.). As another example, in some instances, an action selection 426 can include a selection of a code generation action to be executed by a code generation model 318 different from the machine-learned agent 406. In some instances, an action selection 426 can include code 320 to cause a computing system 102 to generate nonvisual chart data 104 (e.g., JSON-structured chart specification(s) 304, etc.), visual chart(s) 110, or other data. In some instances, an action selection 426 can include a selection of one or more output actions, such as an action selection 426 comprising data to be output (e.g., language output 108 data, etc.) along with data (e.g., delimiter data such as “[Output]:”, etc.) indicative of a selection of an action to provide the output data to a user or other entity (e.g., computing device, etc.). In some instances, data to be output to a user can be included in an action selection 426 or stored in a location separate from the action selection 426, such as in a file, variable, database, or the like. In some instances, an action selection 426 can include data (e.g., filename data, variable name data, numerical database row identifier, etc.) indicative of a location of data to be output, or may not include such data (e.g., in instances when an output value is stored in a default location, etc.).

In some instances, data to be output to a user can include language output(s) 108, visual chart data 110, or other data. For example, in some instances, a machine-learned agent 406 can be provided with a query 414 comprising a natural language request to analyze raw data 216 identified by the query 414; and generate a first action selection 426 comprising code 320 for generating a visual chart 110 and corresponding nonvisual chart data 104 (e.g., JSON-structured chart specification(s) 304, etc.) based on the raw data 216, along with data indicative of an action selection for executing the code 320. A computing system 102 can receive the action selection 426; parse the action selection 426 to identify the selected action and to identify the code 320 to be executed; execute the code 320; and provide one or more action results 428 (e.g., nonvisual chart data 104, success/failure message, variable names or storage location for nonvisual chart data 104 or visual chart(s) 110, etc.) to the machine-learned agent 406. The machine-learned agent 406 can generate, based on the action result(s) 428, a second action selection 426 comprising output data (e.g., language output 108, etc.) or comprising data identifying relevant output data (e.g., variable name or filename of a visual chart 110 to output, etc.), along with data (e.g., delimiter data, etc.) indicative of a selection of an output action to output the output data. The computing system 102 can parse the action selection 426 to identify the selected action and identify the output data to be output, and the computing system 102 can execute the selected action by outputting the output data (e.g., to a user, to another computing device, etc.).

In some instances, an action selection 426 can include a selection of a data retrieval action. For example, in some instances, a query 414 can include a query 414 identifying particular retrievable data to be analyzed, or can include a query 414 asking a general or open-ended question without directly referring to a particular dataset to be analyzed. In some instances, an action selection 426 can include data identifying a dataset or data location and data indicative of a selection of a retrieval action for retrieving the data. In some instances, an action selection 426 can include a selection of an action to search for relevant data to be retrieved (e.g., web search using one or more keywords associated with the query 414, etc.). In some instances, a computing system 102 can parse a generated action selection 426 to identify a selection of a retrieval action and to identify a location (e.g., uniform resource locator (URL), filename, database table name or data entry row identifier, etc.) of data to be retrieved, and the computing system 102 can retrieve the identified data and provide (e.g., within a context window, as a stored variable, etc.) all or part of the retrieved data as action result 428 data.

In some instances, a selected action can be identified by delimiter data in an action selection 426, such as one or more delimiters indicative of a selected code execution action, output action, retrieval action, or other action; one or more delimiters indicative of a beginning or end of a section of the action selection 426 (e.g., beginning or end of code 320, etc.); or other delimiters. In some instances, a conversation history can include delimiter data associated with outputs of the machine-learned agent 406 (e.g., action selections 426, language outputs 108, etc.) and delimiter data associated with input(s) to the machine-learned agent 406 (e.g., queries 414, action result(s) 428, etc.), such as data indicative of conversational turn(s) (“Agent:”, “User:”, etc.), data indicative of a type of content preceding or following the delimiter (e.g., “<code>” and “</code>”, “Results:”, “[JSON GRAPH DESCRIPTION]:”, “{Action Selection}”, etc.), or other delimiter data.

In some instances, a machine-learned agent 406 can be configured (e.g., prompted, fine-tuned, etc.) to process queries 414 and action result(s) 428 to generate action selection(s) 426 by providing (e.g., at inference time as in-context learning content, at training time, etc.) the machine-learned agent 406 with data (e.g., in-context learning content, etc.) to cause the machine-learned agent 406 to generate action selection(s) 426 based on queries 414 or action result(s) 428. Example in-context learning content can include, for example, instruction content, system prompt content, few-shot example content, chain-of-action or chain-of-thought content, or other in-context learning content. In some instances, few-shot or chain-of-action content can include content comprising example query-action selection(s)-action result(s)-output tuples, such as tuples marked by delimiter data indicating which portions of each example form a portion of the query, action selection(s), action result(s), code, output(s), or other content. Other examples are possible.

In some instances, action result(s) 428 can be, comprise, be comprised by, or otherwise share one or more properties with non-visual chart data 104, 304. For example, in some instances, an action result 428 can have any property described herein with respect to non-visual chart data 104, 304, and vice versa.

In some instances, action result(s) 428 can include data indicative of a result of one or more actions associated with an action selection 426, such as output data associated with the action (e.g., output data that was output by a code execution 322 module or other tool; retrieved data that was retrieved from a file or database according to a data retrieval action selection; etc.); a success message or error message (e.g., exception, error code, natural language error message, etc.) indicating that the action did or did not complete successfully; or other data associated with action(s) performed according to one or more action selections 426.

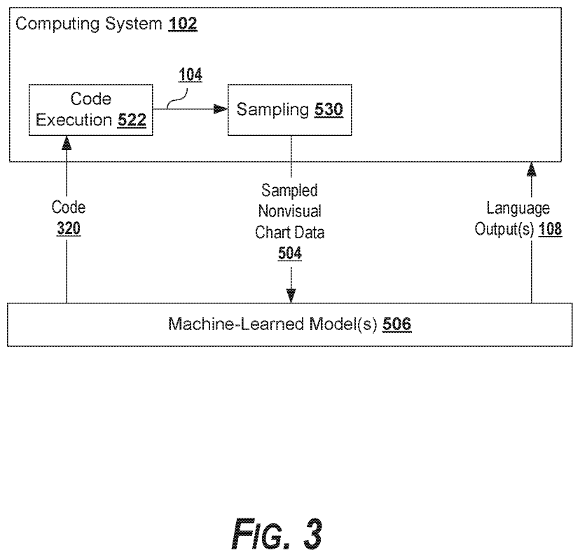

In some instances, action result(s) 428 can include an entirety of a set of result(s) output by a code execution 322 module or other tool, or can include a subset of a set of result(s) output by a computing system 102 or other tool during a selected action. For example, in some instances, action result(s) 428 can include a subsampled set of results, such as action result(s) 428 sampled from a large set of results that may be costly or otherwise undesirable to provide directly to a machine-learned agent 406 in its entirety. Further details of some example systems for subsampling result data are provided below with respect to FIG. 5.

In some instances, action result(s) 428 can include or be combined with interaction history data, such as all or part of a conversation history of a conversation of the machine-learned agent 406. A conversation can be defined, for example, as all interactions between the machine-learned agent 406 and a particular query source 212 (e.g., user, etc.); all interactions between the machine-learned agent 406 and the query source 212 during a particular time period; or in another way, such as based on one or more action(s) taken by a query source 212 to delineate conversation boundaries (e.g., clicking “New Conversation” button, opening new browser tab or window, etc.). In some instances, at each round of action selection 426, the machine-learned agent 406 can be provided with all of an interaction history (e.g. user interaction history comprising queries 414 from a user and outputs to the user; computing system 102 interaction history comprising queries 414, action selections 426, action results 428, outputs, etc.), along with full or partial action result 428 data. For example, in some instances, a machine-learned agent 406 can be provided, at each round, with a full history of queries 414, outputs, and action selections 426, while being provided only with action result 428 data from a most recent action performed by the computing system. Other examples are possible (e.g., providing only success/failure message or summarized action result 428 data from prior rounds, etc.). In some instances, action result 428 data can include all data generated during a most recently executed action, or can include only a subset of such data (e.g., in instances when a full dataset may be too large to be processed efficiently or accurately, etc.). Further details of some example systems for sampling a subset of generated data (e.g., action result data 428, nonvisual chart data 104, etc.) to provide to a machine-learned model 106, 306, 406 are provided below with respect to FIG. 5.

FIG. 5 is a block diagram of an example system for subsampling nonvisual chart data according to example implementations of aspects of the present disclosure. A code execution module 522 of a computing system 102 can execute code 320 generated by one or more machine-learned models 506 to generate first nonvisual chart data 104. A sampling module 530 of the computing system 102 can sample the nonvisual chart data 104 to generate sampled nonvisual chart data 504. The computing system 102 can provide the sampled nonvisual chart data 504 to one or more machine-learned models 506. Based at least in part on the sampled nonvisual chart data 504, the machine-learned model(s) 506 can generate one or more language outputs 108.

In some instances, sampled nonvisual chart data 504 can share one or more properties with nonvisual chart data 104. For example, in some instances, sampled nonvisual chart data 504 can have any property described herein with respect to sampled nonvisual chart data 104, and vice versa. In some instances, sampled nonvisual chart data 504 can be a subset (e.g., strict subset, etc.) of nonvisual chart data 104 from which the sampled nonvisual chart data 504 was sampled.

In some instances, a machine-learned model 506 can be, comprise, be comprised by, or otherwise share one or more properties with a machine-learned model 106, 306, 406. For example, in some instances, a machine-learned model 506 can have any property described herein with respect to a machine-learned model 106, 306, 406, and vice versa.

In some instances, a code execution module 522 can be, comprise, be comprised by, or otherwise share one or more properties with a code execution module 322. For example, in some instances, a code execution module 522 can have any property described herein with respect to a code execution module 322, and vice versa.

A sampling module 530 can be or include one or more software, firmware, or hardware components configured to determine sampled nonvisual chart data 504 based on nonvisual chart data 104. In some instances, the sampling module 530 can be, comprise, be comprised by, or share one or more properties with a computing device or system described below with respect to FIGS. 15-17 (e.g., computing device 50, third-party system 80, computing device 98, computing device 99, etc.).

In some instances, a computing system 102 can determine whether or not to subsample a set of nonvisual chart data 104 based on a size (e.g., length, number of data points or chart objects, size in bytes, etc.) of the nonvisual chart data 104. For example, in some instances, a computing system 102 can compare a size of the nonvisual chart data 104 to a size threshold (e.g., predetermined fixed threshold, adaptive threshold, etc.) and generate sampled nonvisual chart data 504 if the size of the nonvisual chart data 104 exceeds the threshold. In some instances, a threshold can include a threshold associated with a size of a context window of the machine-learned model(s) 506 (e.g., threshold percentage of context window size, etc.), a threshold associated with one or more output quality thresholds (e.g., based on one or more experiments comparing a quality of an output of the machine-learned model 506 to a size of nonvisual chart data 104 used to generate the output, etc.), or other threshold.

In some instances, sampling nonvisual chart data 104 to generate sampled nonvisual chart data 504 can include performing one or more actions to preserve one or more features (e.g., statistical features, etc.) of the nonvisual chart data 104. For example, in some instances, generating sampled nonvisual chart data 504 can include identifying one or more extrema (e.g., minima, maxima, etc.) of the nonvisual chart data 104 and including each datapoint associated with the extrema in the sampled nonvisual chart data 504. In this manner, for instance, statistical properties of the nonvisual chart data 104 associated with minimum or maximum values of the data can be preserved. In some instances, extrema can include extrema on one data dimension or multiple data dimensions (e.g., smallest and largest X value, smallest and largest Y value, smallest and largest value for each of a plurality of data categories, etc.).

In some instances, generating sampled nonvisual chart data 504 can include randomly sampling one or more data points of the nonvisual chart data 104 to include in the sampled nonvisual chart data 504. For example, in some instances, generating sampled nonvisual chart data 504 can include identifying one or more first data points (e.g., extrema, outliers, etc.) to include in the sampled nonvisual chart data 504, and randomly sampling one or more second data points to include in the sampled nonvisual chart data 504 (e.g., randomly sampling from a remainder data set comprising all remaining datapoints of the nonvisual chart data 104 that have not already been selected for inclusion in the sampled nonvisual chart data 504, etc.). In some instances, random sampling can include uniform random sampling, wherein each datapoint of a set of candidate datapoints has an equal or approximately equal chance of being randomly sampled. In some instances, uniform random sampling can be used to preserve or approximately preserve one or more properties or features (e.g., statistical features, etc.) of the nonvisual chart data 104, such as clustering features, mean values, median values, or the like. In some instances, one or more other operations can be used to preserve one or more other properties of the nonvisual chart data 104 (e.g., weighted random sampling; deterministic data point selection; comparing a statistical property of a full nonvisual chart data 104 dataset to a corresponding statistical property of a candidate set of sampled nonvisual chart data 504, and adjusting the candidate set of sampled nonvisual chart data 504 based on the comparison; etc.).

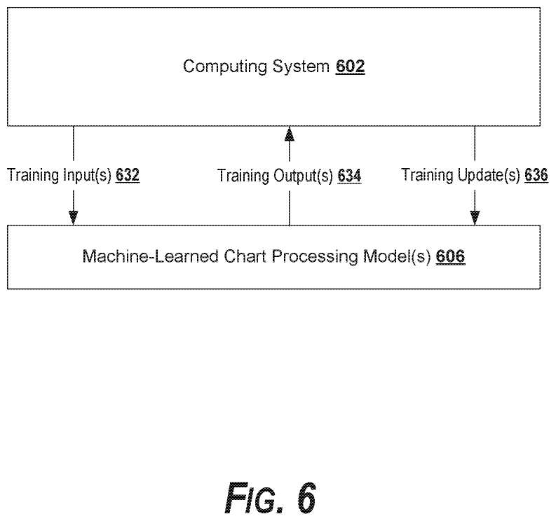

FIG. 6 is a block diagram of an example system for training a machine-learned chart processing model according to example implementations of aspects of the present disclosure. A computing system 602 can provide one or more training inputs 632 to one or more machine-learned chart processing models 606. Based at least in part on the training input(s) 632, the machine-learned chart processing model(s) 606 can generate one or more training outputs 634. Based at least in part on the training output(s) 634, the computing system 602 can provide one or more training updates 636 to the machine-learned chart processing model(s) 606.

In some instances, a computing system 602 can be, comprise, be comprised by, or otherwise share one or more properties with a computing system 102. For example, in some instances, a computing system 602 can have any property described herein with respect to a computing system 102, and vice versa.

In some instances, a machine-learned chart processing model 606 can be, comprise, be comprised by, or otherwise share one or more properties with a machine-learned model 106. For example, in some instances, a machine-learned chart processing model 606 can have any property described herein with respect to a machine-learned model 106, and vice versa.

In some instances, a training input 632 can be, comprise, be comprised by, or otherwise share one or more properties with one or more of nonvisual chart data 104, visual chart 110 data, query 214 data, or the like. For example, in some instances, a training input 632 can have any property described herein with respect to nonvisual chart data 104, visual chart 110 data or query 214 data.

A training output 634 can include, for example, any data output by a machine-learned chart processing model 606 based on one or more training input(s) 632. For example, in some instances, a training output 634 can be, comprise, be comprised by, or otherwise share one or more properties with a language output 108, code 320, or action selection 426. For example, in some instances, a training output 634 can have any property described herein with respect to a language output 108, code 320, or action selection 426, and vice versa.

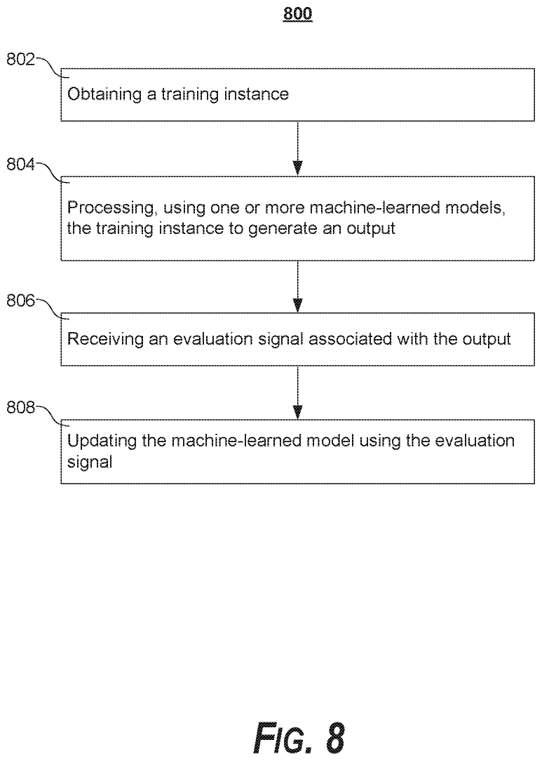

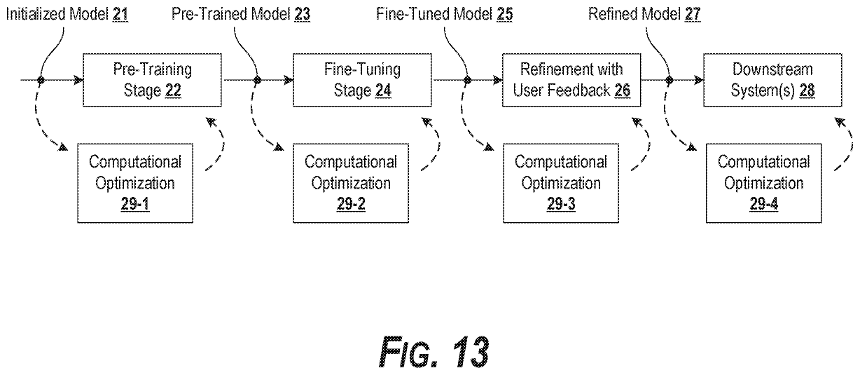

A training update 636 can include, for example, a value (e.g., numerical value, etc.) for updating one or more parameters of the machine-learned chart processing model 606, an action for updating the machine-learned chart processing model 606, or the like. For example, in some instances, a training update 636 value can include a numerical adjustment value to be combined with (e.g., added to, multiplied by, etc.) a parameter of the machine-learned chart processing model 606 to generate an updated parameter. In some instances, a training update 636 can be determined based on an evaluation of a training output 634, such as evaluation using a loss function, reward function, or other objective function. For example, in some instances, a training output 634 can be compared to a ground truth output according to a loss function. In some instances, a gradient of an objective function with respect to one or more training outputs (e.g., mini-batch comprising a plurality of loss values associated with a plurality of training outputs 634, etc.) can be determined, and the training update 636 can be determined based on one or more gradients (e.g., by multiplying the gradient by a constant or adaptive learning rate parameter, etc.). Further details of some example methods for updating a machine-learned model are provided below, such as with respect to FIGS. 8 and 13.

In some instances, training a machine-learned chart processing model 606 can include training based at least in part on one or more of visual chart(s) 110, nonvisual chart data 104, ground truth language output(s) 108, queries 214, or other chart-related training data. For example, in some instances, training a machine-learned chart processing model 606 can include providing nonvisual chart data 104 as a training input 632 (e.g., alone or in combination with a query 214, visual chart 110, etc.) and updating the machine-learned chart processing model 606 based at least in part on a training output 634 (e.g., language output, etc.) generated by the machine-learned chart processing model 606 based on the nonvisual chart data 104. For example, in some instances, a training update 636 can include a comparison between a natural language training output 634 generated by the machine-learned chart processing model 606 based on a training input 632 comprising nonvisual chart data 104 and a corresponding ground truth language output 108 associated with the same training input 632. In some instances, a comparison can include a metric of similarity (e.g., distance metric such as embedding distance, Levenshtein edit distance, etc.) between a training output 634 and ground truth output; a machine-learned comparison such as an entailment classification or the like; or other comparison. In this manner, for instance, a machine-learned chart processing model 606 can be trained (e.g., fine-tuned, etc.) to generate high-quality outputs (e.g., language output(s) 108, etc.) based on inputs comprising nonvisual chart data 104.

As another example, in some instances, training a machine-learned chart processing model 606 can include training based on training input(s) 632 comprising visual chart(s) 110 (e.g., alone or in combination with a corresponding query 214), such as a training input 632 that does not comprise nonvisual chart data 104. For example, in some instances, a machine-learned chart processing model 606 can be trained by providing the model with training input(s) 632 comprising visual chart(s) 110, and evaluating one or more training outputs 634 based at least in part on nonvisual chart data 104 associated with the visual chart(s) 110. For example, in some instances, a training update 636 can be determined based at least in part on a comparison between a training output 634 generated based on a visual chart 110 and corresponding nonvisual chart data 104 associated with the same visual chart 110. Comparison can include, for example, machine-learned comparison such as an entailment classification or accuracy classification indicative of whether a language output 108 accurately describes nonvisual chart data 104 or is entailed by nonvisual chart data 104. Other examples are possible. In some instances, a training update 636 can be determined based at least in part on one or more other comparisons, such as a comparison to a ground truth language output 108 or the like. In this manner, for instance, a machine-learned chart processing model 606 can be trained (e.g., fine-tuned, etc.) to generate high-quality outputs (e.g., language output(s) 108, etc.) based on inputs comprising visual chart(s) 110, such as inputs that may lack nonvisual chart data 104.

### Example Methods

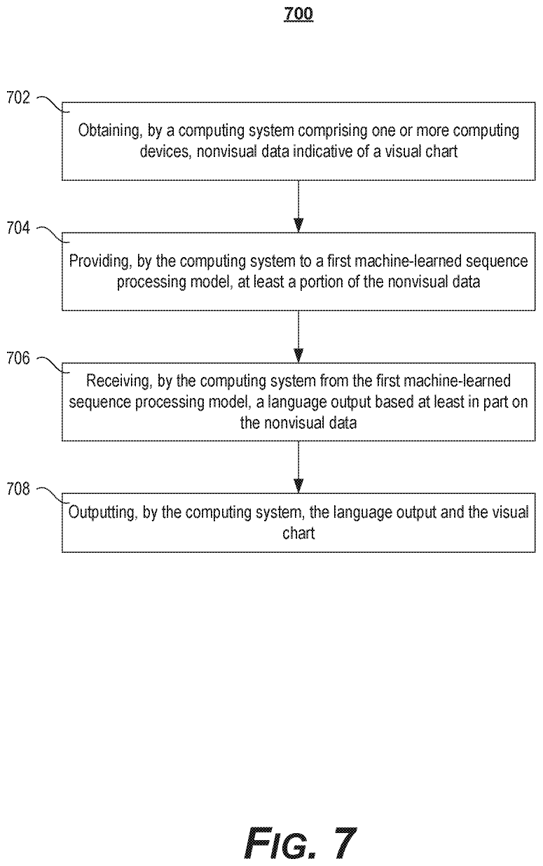

FIG. 7 depicts a flowchart diagram of an example method for machine-learned chart analysis according to example embodiments of the present disclosure. Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

At 702, example method 700 can include obtaining, by a computing system (e.g., computing system 102, etc.) comprising one or more computing devices, nonvisual data (e.g., nonvisual chart data 104, JSON chart specification 304, etc.) indicative of a visual chart (e.g., visual chart 110, etc.). In some instances, example method 700 at 702 can include using one or more systems or performing one or more activities described with respect to FIGS. 1-5.

At 704, example method 700 can include providing, by the computing system to a first machine-learned sequence processing model (e.g., machine-learned model 106, etc.), at least a portion (e.g., sampled nonvisual chart data 504, etc.) of the nonvisual data. In some instances, example method 700 at 704 can include using one or more systems or performing one or more activities described with respect to FIGS. 1-5.

At 706, example method 700 can include receiving, by the computing system from the first machine-learned sequence processing model, a language output (e.g., language output 108, etc.) based at least in part on the nonvisual data. In some instances, example method 700 at 706 can include using one or more systems or performing one or more activities described with respect to FIGS. 1-5.

At 708, example method 700 can include outputting, by the computing system, the language output and the visual chart. In some instances, example method 700 at 708 can include using one or more systems or performing one or more activities described with respect to FIG. 1 or 3-4.

FIG. 8 depicts a flowchart of a method 800 for training one or more machine-learned models according to aspects of the present disclosure. For instance, an example machine-learned model can include a machine-learned model 106, 306, 406, 506, 606.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

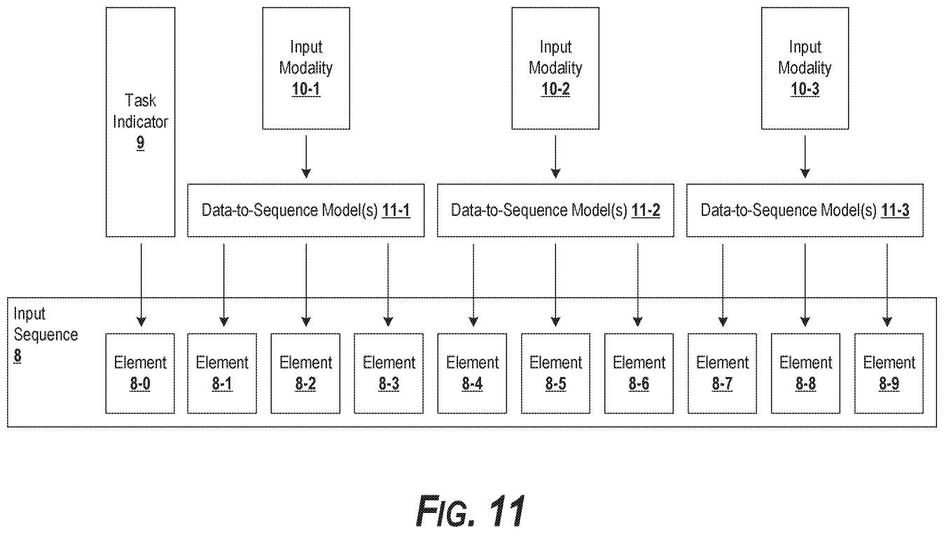

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

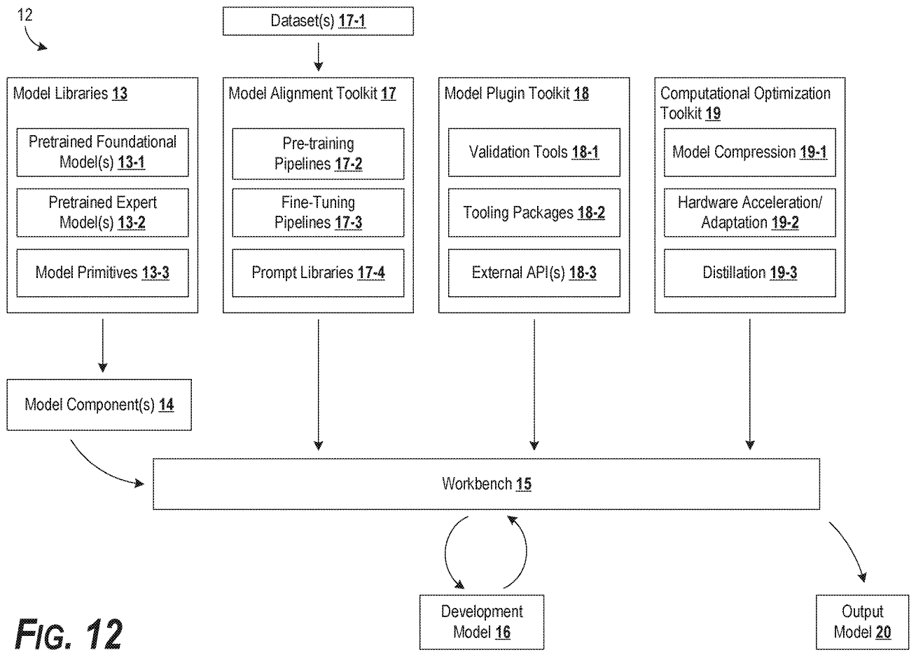

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

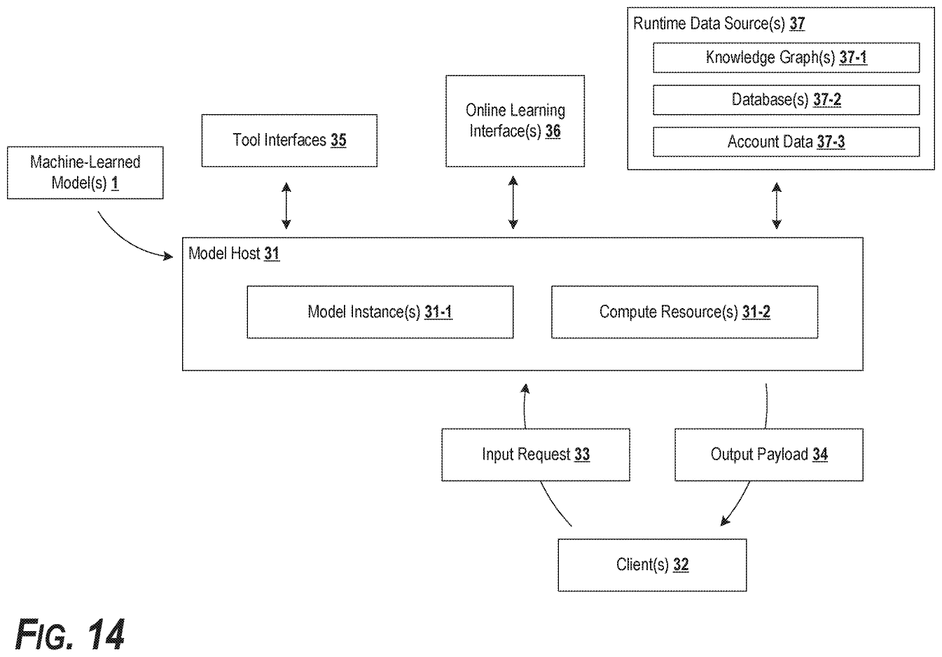

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 32 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing device 50 or server computing system(s) 60 can implement all or a portion of the operations of model development platform system 70. For example, computing device 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing device 50 or server computing system(s) 60 can develop, update/train, or refine machine-learned models based on local datasets (e.g., for model personalization/customization, as permitted by user data preference selections).

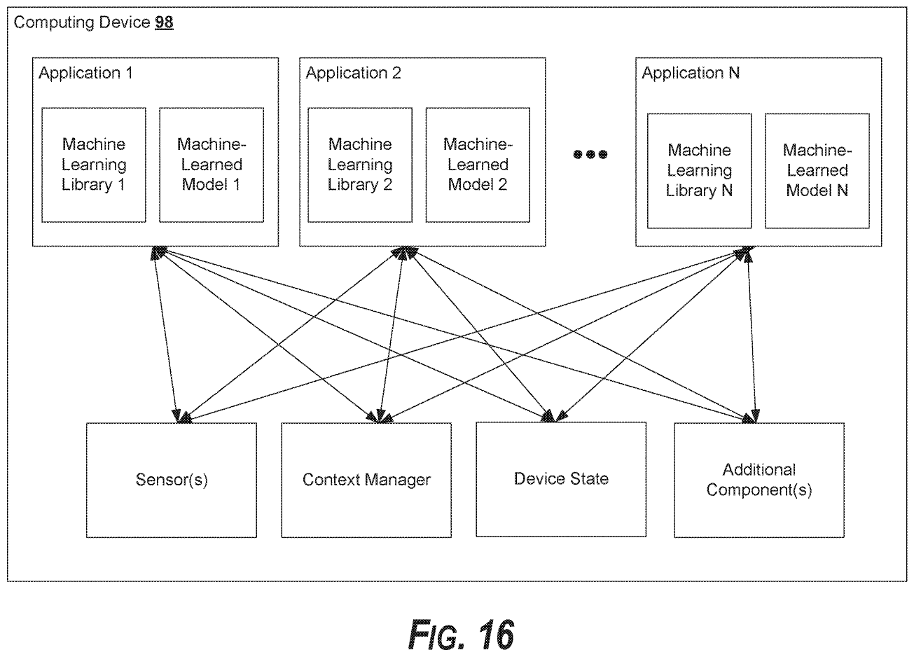

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

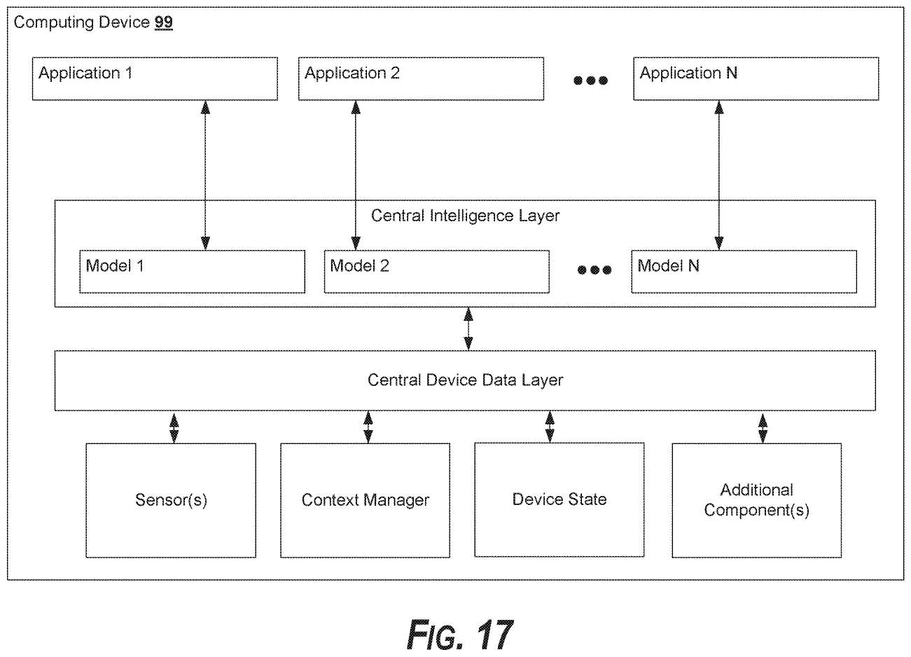

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method, comprising:
obtaining, by a computing system comprising one or more computing devices, a first dataset to be analyzed;
generating, by the computing system using a first machine-learned sequence processing model, one or more computer-readable instructions that are executable by one or more processors to cause the computing system to process the first dataset to generate a visual chart depicting one or more properties of the first dataset and corresponding nonvisual data indicative of the visual chart;
executing, by the computing system, the one or more computer-readable instructions to generate the visual chart and the nonvisual data indicative of the visual chart;
providing, by the computing system to the first machine-learned sequence processing model or a second machine-learned sequence processing model, at least a portion of the nonvisual data;
receiving, by the computing system from the first or second machine-learned sequence processing model, a language output based at least in part on the nonvisual data; and
outputting, by the computing system, the language output and the visual chart.

2. The method of claim 1, wherein generating the one or more computer-readable instructions comprises:
providing, by the computing system to the first machine-learned sequence processing model, data indicative of an application programming interface for processing raw data to generate nonvisual specifications of visual charts; and
receiving, by the computing system from the first machine-learned sequence processing model, the one or more computer-readable instructions.

3. The method of claim 2, wherein the data indicative of the application programming interface comprises one or more of:
documentation data indicative of one or more function signatures of the application programming interface; and
example data comprising one or more example computer-executable instructions for calling the application programming interface.

4. The method of claim 1, further comprising:
sampling, by the computing system responsive to determining that a size of the nonvisual data is greater than a predetermined threshold, a subset of the nonvisual data, wherein providing at least a portion of the nonvisual data comprises providing the subset.

5. The method of claim 4, wherein sampling the subset comprises:
identifying, by the computing system, one or more first data items associated with one or more extrema of the nonvisual data;
including, by the computing system, the one or more first data items in the subset; and
sampling, by the computing system, one or more second data items from a remainder of the nonvisual data.

6. The method of claim 5, wherein sampling the one or more second data items comprises uniform random sampling.

7. The method of claim 1, wherein the nonvisual data comprises a plurality of chart object data items, and wherein each respective chart object data item of the plurality of chart object data items comprises one or more respective coordinates of the respective chart object data item on one or more chart axes of the visual chart.

8. The method of claim 1, wherein the nonvisual data comprises text data indicative of one or more text labels associated with the visual chart.

9. The method of claim 1, wherein the nonvisual data comprises a complete specification of the visual chart in a structured textual data format.

10. The method of claim 9, wherein the structured textual data format comprises a grammar for describing visual charts.

11. The method of claim 1, further comprising:
receiving, by the computing system from a user, a query indicative of a requested analysis of a set of raw data associated with the query;
providing, by the computing system to the first or second machine-learned sequence processing model or a third machine-learned sequence processing model, at least a portion of the query; and
for each of a plurality of iterations:
receiving, by the computing system from the first or second or third machine-learned sequence processing model, an action selection output based at least in part on one or more of the query and result data generated during a previous iteration of the plurality of iterations; and
executing, by the computing system, one or more operations identified in the action selection output.

12. The method of claim 11, wherein the one or more operations for at least one iteration of the plurality of iterations comprise executing the one or more computer-readable instructions to cause the computing system to generate the visual chart and the nonvisual data based on the first dataset.

13. The method of claim 11, wherein the one or more operations for at least one iteration of the plurality of iterations comprise outputting the language output and the visual chart.

14. The method of claim 11, wherein the one or more operations for at least one iteration of the plurality of iterations comprise obtaining the first dataset.

15. The method of claim 1, wherein the nonvisual data is first nonvisual data, the visual chart is a first visual chart, and the first or second machine-learned sequence processing model was trained by:
providing, to the first or second machine-learned sequence processing model, one or more training inputs comprising second nonvisual data indicative of one or more second visual charts;
generating, by the first or second machine-learned sequence processing model, one or more training outputs based on the one or more training inputs; and
updating the first or second machine-learned sequence processing model based at least in part on the one or more training outputs.

16. The method of claim 1, wherein the visual chart is a first visual chart, the language output is a first language output, and further comprising:
providing, by the computing system to the first or second machine-learned sequence processing model or a third machine-learned sequence processing model, a second visual chart;
receiving, by the computing system from the first or second or third machine-learned sequence processing model, a second language output based at least in part on the second visual chart; and
outputting, by the computing system, the second language output and the second visual chart;
wherein the first or second or third machine-learned sequence processing model was trained by:
providing, to the first or second or third machine-learned sequence processing model, one or more training inputs comprising one or more third visual charts;
generating, by the first or second or third machine-learned sequence processing model, one or more training outputs based at least in part on the training inputs; and
updating, based at least in part on a comparison between the one or more training outputs and third nonvisual data indicative of the one or more third visual charts, the first or second or third machine-learned sequence processing model.

17. A computing system comprising one or more processors and one or more non-transitory computer-readable media storing first instructions that are executable by the one or more processors to cause the computing system to perform operations, the operations comprising:
obtaining a first dataset to be analyzed;
generating, using a first machine-learned sequence processing model, one or more second instructions that are executable to cause the computing system to process the first dataset to generate a visual chart depicting one or more properties of the first dataset and corresponding nonvisual data indicative of the visual chart;
executing the one or more second instructions to generate the visual chart and the nonvisual data indicative of the visual chart;
providing, to the first machine-learned sequence processing model or a second machine-learned sequence processing model, at least a portion of the nonvisual data;
receiving, from the first or second machine-learned sequence processing model, a language output based at least in part on the nonvisual data; and
outputting the language output and the visual chart.

18. The computing system of claim 17, wherein generating the one or more second instructions comprises:
providing, to the first machine-learned sequence processing model, data indicative of an application programming interface for processing raw data to generate nonvisual specifications of visual charts; and
receiving, by the computing system from the first machine-learned sequence processing model, the one or more second instructions.

19. The computing system of claim 17, wherein the nonvisual data comprises a complete specification of the visual chart in a structured textual data format.

20. One or more non-transitory computer-readable media storing first instructions that are executable by one or more processors to cause a computing system to perform operations, the operations comprising:
obtaining a first dataset to be analyzed;
generating, using a first machine-learned sequence processing model, one or more second instructions that are executable to cause the computing system to process the first dataset to generate a visual chart depicting one or more properties of the first dataset and corresponding nonvisual data indicative of the visual chart;
executing the one or more second instructions to generate the visual chart and the nonvisual data indicative of the visual chart;
providing, to the first machine-learned sequence processing model or a second machine-learned sequence processing model, at least a portion of the nonvisual data;
receiving, from the first or second machine-learned sequence processing model, a language output based at least in part on the nonvisual data; and
outputting the language output and the visual chart.
